(19) United States
(12) Patent Application Publication
(10) Pub. No.: US 2022/0355800 A1
(43) Pub. Date: Nov. 10, 2022

(54) VEHICLE CONTROL DEVICE

(71) Applicant: HITACHI ASTEMO, LTD., Hitachinaka-shi, Ibaraki (JP)

(72) Inventors: Akitoshi MIYAZAKI, Ibaraki (JP); Keisuke TAKEUCHI, Ibaraki (JP); Masashi SEIMIYA, Ibaraki (JP); Satoshi MATSUDA, Ibaraki (JP)

(73) Assignee: HITACHI ASTEMO, LTD., Hitachinaka-shi, Ibaraki (JP)

(21) Appl. No.: 17/622,548

(22) PCT Filed: Jun. 30, 2020
(86) PCT No.: PCT/JP2020/025611

§ 371 Date: Dec. 23, 2021

(30) Foreign Application Priority Data
Jul. 11, 2019 (JP) 2019-128962

(51) Int. Cl. B60W 40/02; G01C 21/28; B60W 60/00

(52) U.S. Cl. CPC B60W 40/02; G01C 21/28; B60W 60/0015; B60W 2554/20

(57) ABSTRACT

At the time of travel following a travel route, even if an environment around the travel route changes, estimation of a host vehicle position from a stationary object is realized. A vehicle control device has a processor and a memory and controls traveling of a vehicle, and includes a sensor that acquires surrounding environment information of the vehicle, a surrounding environment storage unit that acquires a stationary object from surrounding environment information acquired by the sensor, calculates a position of the stationary object, and stores the position of the vehicle on a travel route and a position of the stationary object in association with each other. The surrounding environment storage unit stores three or more of the stationary objects at each position on a travel route as stationary objects for host vehicle position estimation in a case of receiving a command to start storing the surrounding environment information and the travel route.

### TECHNICAL FIELD

The present invention relates to a vehicle control device.

### BACKGROUND ART

Conventionally, in order to realize an automatic driving system and a parking assistance system of a vehicle, there has been known a vehicle control device that stores a route on which a host vehicle has traveled and surrounding environment information such as a three-dimensional object and a white line around the host vehicle, and, after that, controls the vehicle to travel by following the route stored by the host vehicle as a target route (see, for example, PTL 1).

Examples of the surrounding environment information of a host vehicle include position information regarding three-dimensional objects such as a stationary object and a moving object around the host vehicle, road marks (road marking paint) such as a white line and a stop line on a road, and external surrounding situations such as a traffic light and a speed sign existing around a road.

### CITATION LIST

### Patent Literature

PTL 1: JP 2018-86928 A

### SUMMARY OF INVENTION

### Technical Problem

In order to perform control a host vehicle to follow a route stored by the host vehicle as a target route, it is necessary to estimate a host vehicle position with high accuracy. As a method of estimating the host vehicle position, a method of dead reckoning of estimating the host vehicle position by using host vehicle sensor information such as a wheel sensor, a steering angle sensor, an acceleration sensor, and a gyro sensor, a method of using a global positioning system (GPS), a method of storing an environment around a route in advance and estimating the host vehicle position by collating information acquired by an external recognition sensor such as a camera and lidar with information stored in advance during target route following travel, and the like are known.

However, in the host vehicle position estimation by dead reckoning, as a travel distance increases, the accuracy is deteriorated because errors accumulate. In the method using a GPS as well, in a case where there is a building or the like around a host vehicle, the accuracy is deteriorated because the building reflects a radio wave from a satellite.

In contrast, in the method in which an environment around a route is stored in advance and a host vehicle position is estimated by collating stationary object information acquired by an external recognition sensor such as a camera or lidar with stationary object information around the route stored in advance during route following travel, the accuracy of the host vehicle position estimation depends on the accuracy of the external recognition sensor, and the host vehicle position can be estimated with high accuracy by using a high-performance sensor. Note that the stationary object here refers to an object that is not moving at the time of recognition by the external recognition sensor.

However, in a case where the surrounding environment of the stored route changes and the stored stationary object disappears during the target route following travel, there is a problem that the host vehicle position cannot be estimated. Further, in a case where the number of detected stationary objects is one, it is not possible to determine where the host vehicle is located on the circumference whose radius is a distance between the host vehicle and the detected stationary object around the detected stationary object. For this reason, there is a problem that it is not possible to estimate the host vehicle position on the basis of a relative positional relationship between the detected stationary object and the host vehicle without detecting at least two stationary objects.

### Solution to Problem

The present invention is a vehicle control device that has a processor and a memory and controls traveling of a vehicle, and includes a sensor that acquires surrounding environment information of the vehicle, and a surrounding environment storage unit that acquires a stationary object from surrounding environment information acquired by the sensor, calculates a position of the stationary object, and stores the position of the vehicle on a travel route and a position of the stationary object in association with each other. The surrounding environment storage unit stores three or more of the stationary objects at each position on a travel route as stationary objects for host vehicle position estimation in a case of receiving a command to start storing the surrounding environment information and the travel route.

### Advantageous Effects of Invention

Therefore, in the present invention, three or more stationary objects are simultaneously stored as stationary objects for host vehicle position estimation, so that a host vehicle position can be estimated from two or more stationary objects even in a case where an environment around a travel route changes and one stationary object disappears at the time of travel following the travel route. In this manner, a vehicle control unit can allow traveling of a vehicle to continue by following the target route.

Details of at least one implementation of the subject matter disclosed herein are set forth in the accompanying drawings and description below. Other features, aspects, and effects of the disclosed subject matter will be clarified in disclosure, drawings, and claims below.

### BRIEF DESCRIPTION OF DRAWINGS

FIG. 1 is a diagram illustrating a first embodiment of the present invention and an example of a configuration of a vehicle.

FIG. 2 is a block diagram illustrating the first embodiment of the present invention and an example of a function of a driving assistance system.

FIG. 3 is a plan view illustrating the first embodiment of the present invention and an example of a travel environment using the driving assistance system.

FIG. 4 is a flowchart illustrating the first embodiment of the present invention and an example of processing in which a vehicle control device stores a travel route and a route surrounding environment.

FIG. 5 is a flowchart illustrating the first embodiment of the present invention and an example of processing in which the vehicle control device performs following travel by using a travel route stored in a storage unit as a target route.

FIG. 6 is a flowchart illustrating a second embodiment of the present invention and an example of the processing in which the vehicle control device performs following travel by using a travel route stored in a storage unit as a target route.

FIG. 7 is a flowchart illustrating a third embodiment of the present invention and an example of the processing in which the vehicle control device performs following travel by using a travel route stored in a storage unit as a target route.

FIG. 8 is a flowchart illustrating a fourth embodiment of the present invention and an example of the processing in which the vehicle control device performs following travel by using a travel route stored in a storage unit as a target route.

FIG. 9 is a flowchart illustrating a fifth embodiment of the present invention and an example of the processing in which the vehicle control device performs following travel by using a travel route stored in a storage unit as a target route.

FIG. 10 is a flowchart illustrating a sixth embodiment of the present invention and an example of the processing in which the vehicle control device performs following travel by using a travel route stored in a storage unit as a target route.

FIG. 11 is a flowchart illustrating a seventh embodiment of the present invention and an example of the processing in which the vehicle control device stores a travel route and a route surrounding environment.

FIG. 12 is a flowchart illustrating a seventh embodiment of the present invention and an example of the processing in which the vehicle control device performs following travel by using a travel route stored in a storage unit as a target route.

FIG. 13 is a flowchart illustrating an eighth embodiment of the present invention and an example of the processing in which the vehicle control device performs following travel by using a travel route stored in a storage unit as a target route.

### DESCRIPTION OF EMBODIMENTS

Hereinafter, embodiments of the present invention will be described with reference to the accompanying drawings.

### First Embodiment

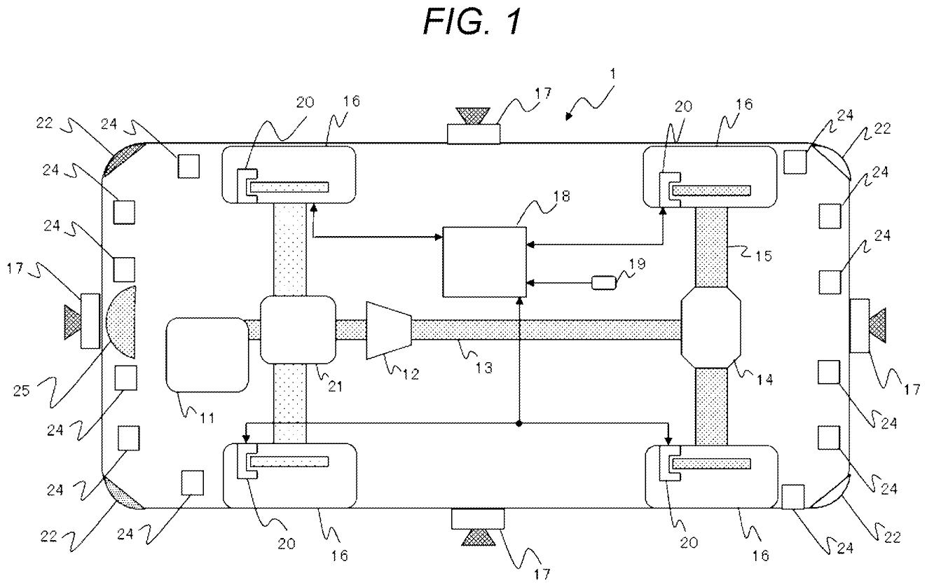

FIG. 1 is a diagram illustrating an example of a configuration of a vehicle according to the present invention. A vehicle 1 as illustrated is a rear-wheel-drive vehicle including, for example, a cylinder injection type gasoline engine 11 as a traveling power source, an automatic transmission 12 capable of transmitting a driving force of the engine 11, a propeller shaft 13, a differential gear 14, a drive shaft 15, four of wheels 16 and brake devices 20 including a wheel sensor, and an electric power steering 21.

In the vehicle 1, a device including a vehicle control device 18 and various sensors 19 to be described later, an actuator, and devices can exchange a signal and data through in-vehicle LAN or CAN communication. The vehicle control device 18 obtains information on the outside of a host vehicle from sensors to be described later, and transmits a command value for realizing control such as automatic parking and automatic driving to the engine 11, the brake device 20 including a wheel sensor, the electric power steering 21, and the automatic transmission 12. The wheel sensor 50 generates a pulse waveform according to rotation of a wheel and transmits the pulse waveform to the vehicle control device 18.

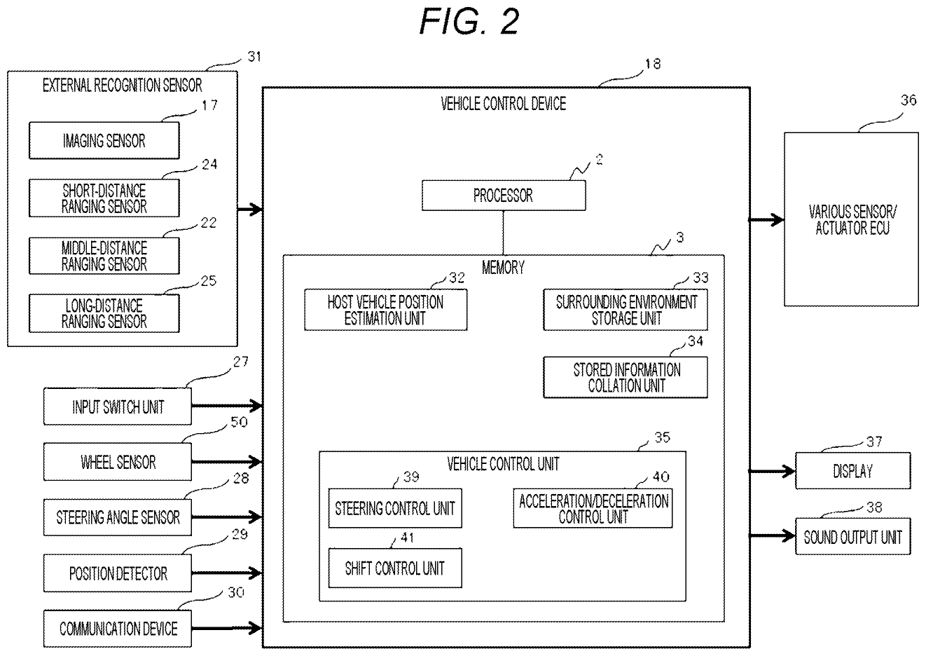

An imaging sensor 17 and a short-distance ranging sensor 24 are arranged on the front, rear, and side of the vehicle 1. Further, a middle-distance ranging sensor 22 is arranged on the front and rear of the vehicle 1. Further, a long-distance ranging sensor 25 is arranged on the front of the vehicle 1. These sensors function as an external recognition sensor 31 (FIG. 2) that detects a road environment such as a three-dimensional object and a white line around the host vehicle and supplies it to the vehicle control device 18. Mounting positions of these and the number of various sensors are not limited to the positions illustrated in FIG. 1.

Note that the illustrated vehicle 1 is an example of a vehicle to which the present invention can be applied, and the present invention does not limit a configuration of a vehicle to which the present invention can be applied. For example, a vehicle employing a continuously variable transmission (CVT) instead of the automatic transmission 12 may be used. Further, instead of the engine 11 as a traveling power source, a vehicle including a motor or an engine and a motor as a traveling power source may be used.

FIG. 2 is a block diagram illustrating an example of a function of a driving assistance system to which the present invention is applied. The driving assistance system illustrated in FIG. 2 is mounted on the vehicle 1, and includes the external recognition sensor 31, an input switch unit 27, a wheel sensor 50, a steering angle sensor 28, a position detector 29, a display 37, a sound output unit 38, a communication device 30, a various sensor/actuator ECU 36 of a vehicle, and the vehicle control device 18 connecting these components. Further, the external recognition sensor 31 includes the imaging sensor 17, a short-distance ranging sensor 24, the middle-distance ranging sensor 22, and the long-distance ranging sensor 25.

The vehicle control device 18 includes a processor 2 and a memory 3. The vehicle control device 18 loads programs of a host vehicle position estimation unit 32, a surrounding environment storage unit 33, a stored information collation unit 34, and a vehicle control unit into the memory 3 and executes the programs by the processor 2. The vehicle control unit 35 includes a steering control unit 39, an acceleration/deceleration control unit 40, and a shift control unit 41.

The processor 2 operates as a functional unit that provides a predetermined function by executing processing according to a program of each functional unit. For example, the processor 2 functions as the host vehicle position estimation unit 32 by executing processing according to a host vehicle position estimation program. The above similarly applies to other programs. Furthermore, the processor 2 also operates as a functional unit that provides a function of each of a plurality of pieces of processing executed by each program. A computer and a computer system are a device and a system including these functional units.

The imaging sensor 17 can include, for example, a camera. The imaging sensor 17 is used to capture information of a three-dimensional object, a white line, or a sign by an imaging element attached around the host vehicle. Further, in the example illustrated in FIG. 2, one camera is used. However, a stereo camera having two cameras may be used. Imaging data by the imaging sensor 17 can be synthesized and processed like, for example, an overhead image representing a state viewed from a virtual viewpoint above the vehicle from which the periphery of the vehicle can be displayed. The imaging data by the imaging sensor 17 is input to the vehicle control device 18.

The short-distance ranging sensor 24 can be configured by, for example, sonar. The short-distance ranging sensor 24 is used to transmit an ultrasonic wave toward the periphery of the vehicle 1 and receive a reflected wave to detect a distance to a three-dimensional object in the vicinity of the host vehicle. Distance measurement data by the short-distance ranging sensor 24 is input to the vehicle control device 18.

The middle-distance ranging sensor 22 can be configured by, for example, a millimeter wave radar. The middle-distance ranging sensor is used to transmit a high frequency wave called a millimeter wave toward the periphery of the vehicle 1 and receive a reflected wave to detect a distance to a three-dimensional object. Distance measurement data by the middle-distance ranging sensor 22 is input to the vehicle control device 18.

The long-distance ranging sensor 25 can be configured by, for example, a millimeter wave radar. The long-distance ranging sensor 25 is used to transmit a high frequency wave called a millimeter wave toward the front of the vehicle 1 and receive a reflected wave to detect a distance to a distant three-dimensional object. Further, the long-distance ranging sensor 25 is not limited to a millimeter wave radar, and may be configured by a stereo camera or the like. Distance measurement data by the long-distance ranging sensor 25 is input to the vehicle control device 18.

The input switch unit 27 is, for example, a dedicated mechanical switch provided around the driver's seat. Further, in a case where the display 37 is configured by a touch panel, the input switch unit 27 may be a graphical user interface (GUI) switch or the like. The input switch unit 27 receives an instruction to store a surrounding environment of the vehicle 1 or an instruction to automatically control the vehicle by user operation.

The wheel sensor 50 includes a wheel speed sensor that is attached to each of the wheels 16 of the vehicle 1 and detects a rotational speed of the wheel 16, and a controller that generates a vehicle speed signal by integrating detection values detected by the wheel speed sensor. Vehicle speed signal data from the wheel sensor 50 is input to the vehicle control device 18. Note that, in the first to sixth and eighth embodiments described later, the wheel sensor 50 can be omitted.

The steering angle sensor 28 is attached to a steering shaft (not illustrated) of the vehicle 1 and includes a sensor that detects a steering direction and a steering angle, and a controller that generates a steering angle signal from a value detected by the sensor. Steering angle signal data from the steering angle sensor 28 is input to the vehicle control device 18. Note that the steering angle sensor 28 can be omitted.

The position detector 29 includes an azimuth sensor that measures an azimuth of the front of the vehicle 1 and a GPS receiver for a global positioning system (GPS) that measures a position of the vehicle on the basis of radio waves from satellites. Note that, in the first to seventh embodiments of the present invention described later, the position detector 29 can be omitted.

The display 37 includes, for example, a liquid crystal display, and displays, on a display screen of the display 37, an overhead image generated from an image captured by an imaging sensor 17 described later or an image of an image signal from the vehicle control device 18. Note that the display 37 may include a touch panel that functions as an input device.

The sound output unit 38 includes, for example, a speaker, is arranged in an appropriate location in the vehicle interior of the vehicle 1, and is used for voice guidance to the user and output of a warning sound.

The communication device 30 is a device that exchanges communication from the outside, and acquires, for example, road surface information (road surface paint type and position such as a lane marker position, a stop line position, a crosswalk, and the like) and three-dimensional object information (three-dimensional object existing around a road, such as a sign, a traffic light, and a feature) as road information around the vehicle 1.

As described later, as these pieces of information, information detected by a sensor installed in a road infrastructure, road peripheral information (road surface information, three-dimensional object information, and the like) stored in an external data center, and road peripheral information (road surface information, three-dimensional object information, and the like) detected by another vehicle can be acquired by using the communication device 30. Further, it is also possible to change road information around a traveling position stored in advance to latest information by using the communication device 30.

The various sensor/actuator ECU 36 may be one that is well-known or publicly-known, and indicates, for example, a mechanical element such as an accelerator pedal for operating a driving force, a brake pedal for operating a braking force, a parking brake, a steering for operating a traveling direction of a vehicle, and a shift lever for operating a traveling direction of the vehicle, and a signal conversion device.

The vehicle control unit 35 calculates a target value for controlling the various sensor/actuator ECU 36 when performing low-speed automatic driving, and outputs a control instruction.

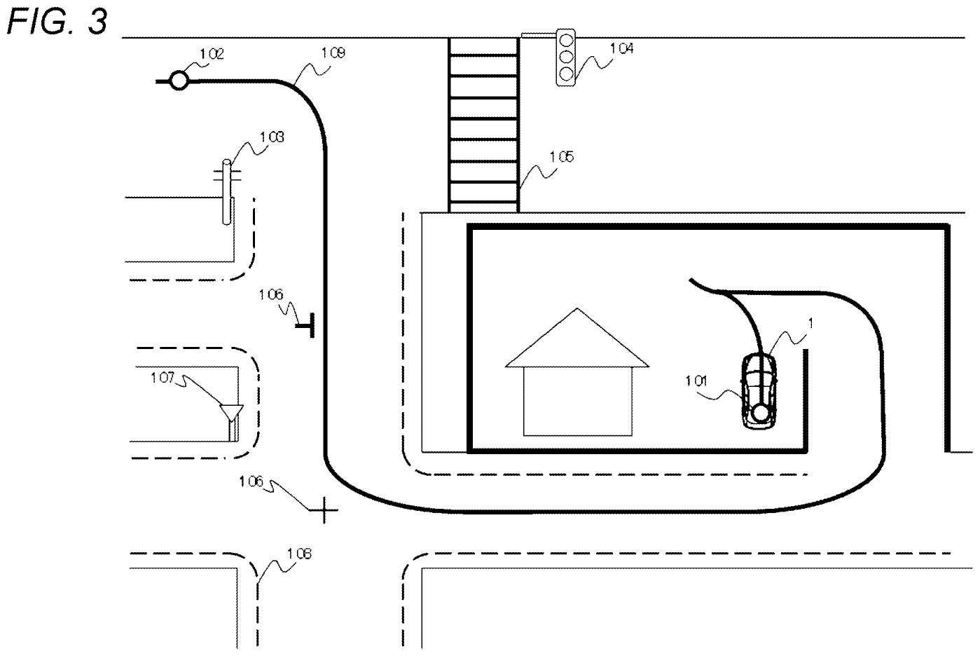

The first embodiment of the present invention will be described with reference to FIGS. 3, 4, and 5.

FIG. 3 is a plan view illustrating an example of a travel environment of the vehicle 1 including the driving assistance system. FIG. 3 illustrates a scene where the vehicle 1 travels to a storage location through a route used on a daily basis and stops at a parking position 101.

In a case where the user (driver) drives the vehicle 1 by himself/herself, when an instruction to start storing the surrounding environment information is given at a storage start position 102, the vehicle control device 18 stores a travel route 109 of the vehicle 1 after that and the environment information around the travel route in the surrounding environment storage unit 33. Specifically, in FIG. 3, an object to be stored is a stationary object (three-dimensional object information or road surface information) that does not move at the time of being recognized by the external recognition sensor 31, such as a utility pole 103 that exists beside a road, a traffic light 104, a crosswalk 105, a sign 107, a road mark 106, and a white line 108. Further, in a case where the user instructs to store a parking start position in a case of starting parking by his/her driving operation, the vehicle control device 18 stores a position of the storage start position 102.

In a case where the vehicle 1 travels to the parking position 101 through the same travel route 109 next in a state where the storage of the surrounding environment information is completed, when the vehicle 1 reaches the storage start position 102, the vehicle control device 18 notifies the user that automatic traveling is possible. Here, when the user instructs to start automatic traveling, the vehicle control device 18 controls steering and a vehicle speed, so that the vehicle 1 performs automatic traveling while following the stored travel route 109.

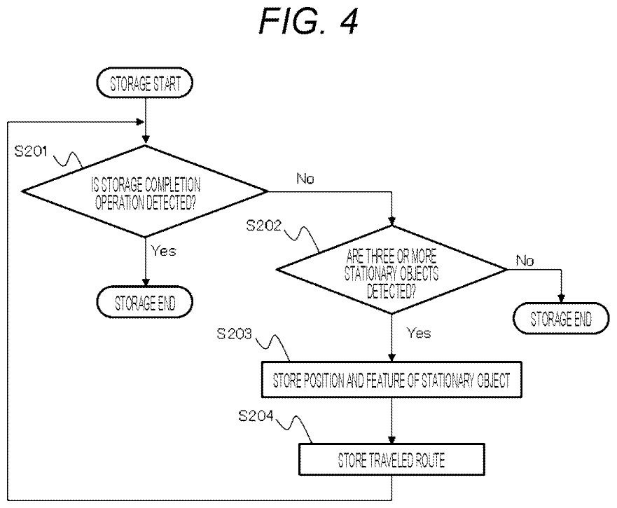

Here, processing of storing a travel route and a route surrounding environment will be described with reference to FIG. 4.

In a case where the vehicle 1 is traveling by driving operation of the user, when the user performs predetermined operation on the input switch unit 27, the vehicle control device 18 starts to store a travel route and a route surrounding environment.

FIG. 4 is a flowchart illustrating an example of processing executed by the vehicle control device 18 when the vehicle 1 stores surrounding environment information while traveling by the user's driving. This processing is executed in a case where a predetermined command to start storing the surrounding environment information is received from the input switch unit 27.

When the storage of a travel route and a route surrounding environment is started, the surrounding environment storage unit 33 of the vehicle control device determines whether or not the user performs predetermined operation on the input switch unit 27 and storage completion operation is performed (Step S201). The determination processing as to whether the user performs the storage completion operation may be performed continuously in terms of time, or may be performed discretely in a certain cycle.

In a case where it is determined that the user performs the storage completion operation, the storage processing ends. At that time, the surrounding environment storage unit 33 may display a predetermined message to notify the user that the storage is successful on the display 37.

When it is determined that the user does not perform the storage completion processing, the surrounding environment storage unit 33 acquires surrounding environment information around the vehicle 1 from the external recognition sensor 31, and detects a stationary object from the surrounding environment information. Then, the surrounding environment storage unit 33 determines whether or not the external recognition sensor 31 detects three or more stationary objects (Step S202).

In a case where three or more stationary objects are not detected, the surrounding environment storage unit 33 ends the storage processing. At that time, the surrounding environment storage unit 33 may display a predetermined message to notify the user that the storage fails on the display 37.

In a case where three or more stationary objects are detected, the surrounding environment storage unit 33 stores positions and features of the stationary objects in the surrounding environment storage unit 33 (Step S203). Hereinafter, the stored stationary object is referred to as the stationary object for host vehicle position estimation.

Specific examples of the position include a method of storing, as a position, a coordinate value of a stationary object in a case where the storage start position 102 is set as the origin, and a method of storing, as a position, a coordinate value of a stationary object in a case where the parking position 101 is set as the origin. Note that in a case where the host vehicle position estimation unit 32 estimates the position of the vehicle, for a coordinate value of the stationary object, the position of the stationary object may be calculated from a distance and an angle to the stationary object with an estimated value of the host vehicle position as the origin.

Further, specific examples of a feature of the stationary object include a value (for example, a feature amount) calculated by substituting a color, a size, an outer shape, and a sensor value of the stationary object into a predetermined calculation formula. After storing the position and the feature of the stationary object detected by the external recognition sensor 31, the surrounding environment storage unit 33 stores a route (the travel route 109) on which the vehicle has traveled up to the present in the surrounding environment storage unit 33. The vehicle control device 18 executes the processing from Step S201 to Step S204 in a certain cycle until the storage processing ends.

Note that the travel route 109 is stored in a coordinate system with the storage start position 102 as the origin based on a travel distance from the storage start position 102 and a distance or an azimuth from the position of the vehicle 1 to the stationary object for host vehicle position estimation. Note that the travel route 109 is not limited to the above, and only needs to be information based on a relationship between a travel distance from the storage start position 102 at each position on the travel route 109 and position information of the stationary object for host vehicle position estimation.

By the above processing, in the vehicle control device 18, when receiving a predetermined command to start storing the surrounding environment information from the input switch unit 27 (input unit), the surrounding environment storage unit 33 periodically stores the position on the travel route 109 and the stationary object for host vehicle position estimation.

The surrounding environment storage unit 33 detects three or more stationary objects at each position on the travel route 109 that is periodically stored, calculates the positions and features of the stationary objects, and stores the positions and features as a stationary object for host vehicle position estimation.

Although FIG. 4 illustrates an example in which the surrounding environment storage unit 33 stores the position on the travel route 109 and the stationary object for host vehicle position estimation by loop processing, the present invention is not limited to this example, and the position on the travel route 109 and the stationary object for host vehicle position estimation may be stored at predetermined intervals. For example, the surrounding environment storage unit 33 may store the position on the travel route 109 and the stationary object for host vehicle position estimation at predetermined time intervals or at predetermined distances.

Further, in the above example, the surrounding environment storage unit 33 ends the storage processing at the position where the user performs the storage completion operation with the input switch unit 27. However, the parking position 101 may be set by ending the storage in the surrounding environment storage unit 33 at the position where the user (driver) operates a parking brake (or parking range).

Next, processing of following travel on the travel route 109 stored in the surrounding environment storage unit 33 of the vehicle control device 18 as a target route will be described.

In a case where the surrounding environment storage unit 33 stores information on the travel route 109 and the stationary object for host vehicle position estimation around the route, when the user performs predetermined operation with the input switch unit 27, the vehicle 1 starts following travel (automatic driving) on the stored travel route 109 as a target route.

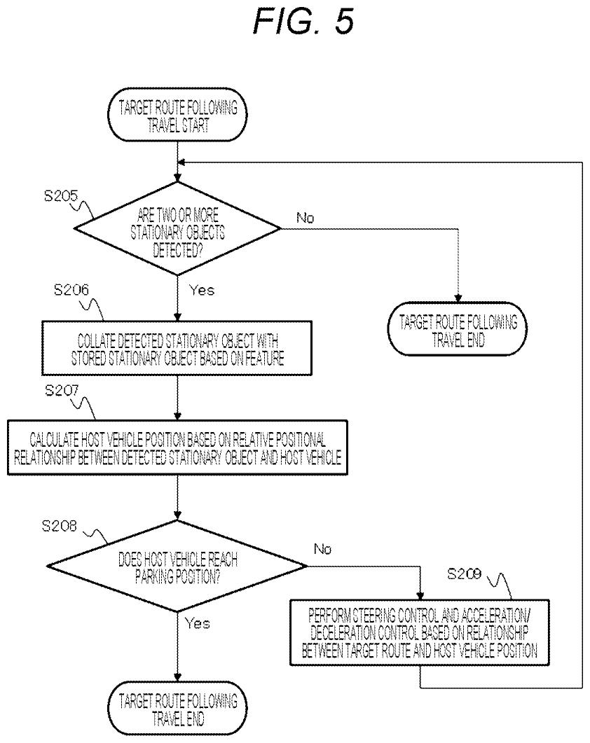

FIG. 5 is a flowchart illustrating an example of processing executed by the stored information collation unit 34 and the vehicle control unit 35 of the vehicle control device 18 when the vehicle 1 performs following travel on the travel route 109 stored in the surrounding environment storage unit 33 as a target route.

When the target route following travel is started, the stored information collation unit 34 of the vehicle control device 18 determines whether or not the external recognition sensor 31 detects two or more stationary objects (Step S205). In a case where the external recognition sensor 31 does not detect two or more stationary objects, the stored information collation unit 34 ends the target route following travel. When the target route following travel is stopped, the stored information collation unit 34 may display a predetermined message on the display 37 to notify the user that the target route following travel has failed.

In a case where the external recognition sensor 31 detects two or more stationary objects, the stored information collation unit 34 performs collation to determine which of the stationary objects for host vehicle position estimation stored in the surrounding environment storage unit 33 the detected stationary object corresponds to, based on a feature of the detected stationary object (Step S206).

When the collation is completed, the stored information collation unit 34 estimates the position of the host vehicle (host vehicle position) using a relative positional relationship with the stationary object for host vehicle position estimation detected by the host vehicle position estimation unit 32 (Step S207).

As a specific method of the host vehicle position estimation performed by the host vehicle position estimation unit 32, it is possible to use a method of drawing a circle with a radius of a distance between the detected stationary object and the vehicle 1 around the detected stationary object for each of the detected stationary objects, calculating an intersection of the circles, and estimating a point at which a vehicle yaw angle coincides from among a plurality of obtained intersections as the host vehicle position.

Alternatively, the host vehicle position estimation unit 32 can compare an azimuth of a stationary object observed from the vehicle 1 with an azimuth of a stationary object observed from each intersection, and estimate an intersection where the azimuths observed from the vehicle 1 are approximate or coincide with each other as the vehicle position.

Note that the method by which the host vehicle position estimation unit 32 estimates the host vehicle position is not limited to the above, and can be calculated by a well-known or publicly-known method from positions of a plurality of stationary objects for host vehicle position estimation and a distance and angle from the vehicle 1 to the stationary object for host vehicle position estimation.

After the host vehicle position estimation unit 32 estimates the host vehicle position, the vehicle control unit 35 of the vehicle control device 18 determines whether or not the vehicle 1 reaches the parking position 101 (Step S208). When determining that the vehicle 1 reaches the parking position 101, the vehicle control unit 35 ends the target route following travel. When ending the target route following travel, the vehicle control unit 35 may display a predetermined message on the display 37 to notify the user that the target route following travel is successful.

In a case where it is determined that the vehicle 1 does not reach the parking position 101, the vehicle control unit 35 performs steering control and acceleration/deceleration control on the basis of a relationship between the target route (travel route 109) and the host vehicle position (Step S209).

Specifically, the vehicle control unit 35 performs steering control to reduce an error between the target route (travel route 109) and the host vehicle position in the vehicle width direction, and performs acceleration/deceleration control to increase a vehicle speed in a case where a distance between the host vehicle position and an end point of the target route is long and to decrease the vehicle speed in a case where a distance between the host vehicle position and the parking position 101 is short.

Note that the automatic driving by the vehicle control unit 35 is not limited to the above, and a publicly-known or well-known method can be employed.

The vehicle control unit 35 executes the processing from Step S205 to Step S209 in a certain cycle until the target route following travel ends.

By the above processing, when the vehicle control device 18 receives, from the input switch unit 27 (input unit), a command to perform following travel on the travel route 109 as a target route, the stored information collation unit 34 detects two or more stationary objects from the surrounding environment information acquired from the external recognition sensor 31, and identifies a stationary object matching the stationary object for host vehicle position estimation stored in the surrounding environment storage unit 33. Then, the host vehicle position estimation unit 32 estimates the host vehicle position from the positions of the two or more identified stationary objects for host vehicle position estimation, and the vehicle control unit 35 performs control so that an estimated value of the host vehicle position follows the target route.

As described above, in a case where the vehicle control device 18 according to the first embodiment stores the travel route 109 and the surrounding environment information around the route, the vehicle control device 18 simultaneously stores three or more stationary objects as stationary objects for host vehicle position estimation. In this manner, even in a case where the environment around the travel route 109 changes during target route following travel and one stationary object disappears, the host vehicle position can be estimated from two or more stationary objects, and the vehicle control unit 35 can cause the vehicle 1 to travel by following the target route.

### Second Embodiment

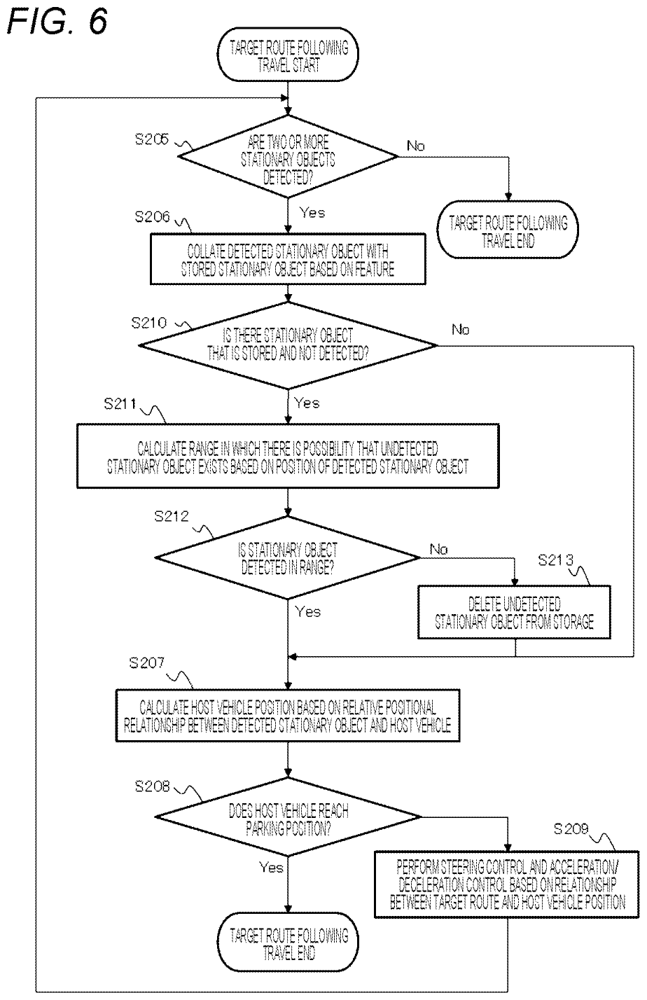

Next, the second embodiment of the present invention will be described with reference to FIG. 6.

FIG. 6 is a flowchart illustrating an example of processing executed by the vehicle control device 18 when the vehicle 1 performs following travel on the travel route 109 stored in the surrounding environment storage unit 33 as a target route in the second embodiment.

A difference between the first embodiment and the second embodiment is processing after Step 210 in FIG. 6, and the configuration of the vehicle 1, the configuration of the driving assistance system, and the storage processing of the travel route 109 and the route surrounding environment of the second embodiment are similar to those of the above embodiment.

FIG. 6 of the second embodiment is obtained by adding processing of Steps S210 to S213 between Steps S206 and S207 of FIG. 5 of the first embodiment. Hereinafter, the same steps as those in the first embodiment will not be described repeatedly.

In the second embodiment, after the stored information collation unit 34 collates a stationary object detected by the external recognition sensor 31 with a stationary object for host vehicle position estimation stored in the surrounding environment storage unit 33, it is determined whether there is an undetected stationary object among the stationary objects stored as the stationary objects for host vehicle position estimation (Step S210). Specifically, it is determined whether there is a stationary object that has not been detected at the present time among stationary objects that have been detected at the present time and stationary objects for host vehicle position estimation are simultaneously stored at the time of storage.

For example, there is a case where a stationary object for host vehicle position estimation held in the surrounding environment storage unit 33 disappears, such as a case where another vehicle that is stopped at the time of storage of the surrounding environment information moves and cannot be detected at the time of following travel.

In a case where there is an undetected stationary object among stationary objects for host vehicle position estimation, the stored information collation unit 34 detects a stationary object again in a range in which there is a possibility that an undetected stationary object exists based on a position of the detected stationary object (Step S211). The range in which there is a possibility that an undetected stationary object exists is calculated on the basis of the performance of the external recognition sensor 31 or the like.

Specifically, there is a method in which the stored information collation unit 34 sets a region having a predetermined size (or radius) around a position where an undetected stationary object should exist as a range in which the undetected stationary object may exist. The predetermined size is set on the basis of the performance of the external recognition sensor 31.

In a case where the stationary object is not detected within the range calculated in Step S211 during the target route following travel, the stored information collation unit 34 determines that the stationary object for host vehicle position estimation no longer exists (S212), and deletes information on the stationary object for host vehicle position estimation that cannot be detected from the surrounding environment storage unit 33 (Step S213).

In the second embodiment, by deleting information that becomes unnecessary from the surrounding environment storage unit 33, free space of the surrounding environment storage unit 33 can be expanded, and new information can be stored. Specifically, information on a newly detected static object for host vehicle position estimation is stored, or a new feature may be added and stored for a static object for host vehicle position estimation that has already been stored. Processing after information that has become unnecessary is deleted from the surrounding environment storage unit 33 is similar to that in the first embodiment.

### Third Embodiment

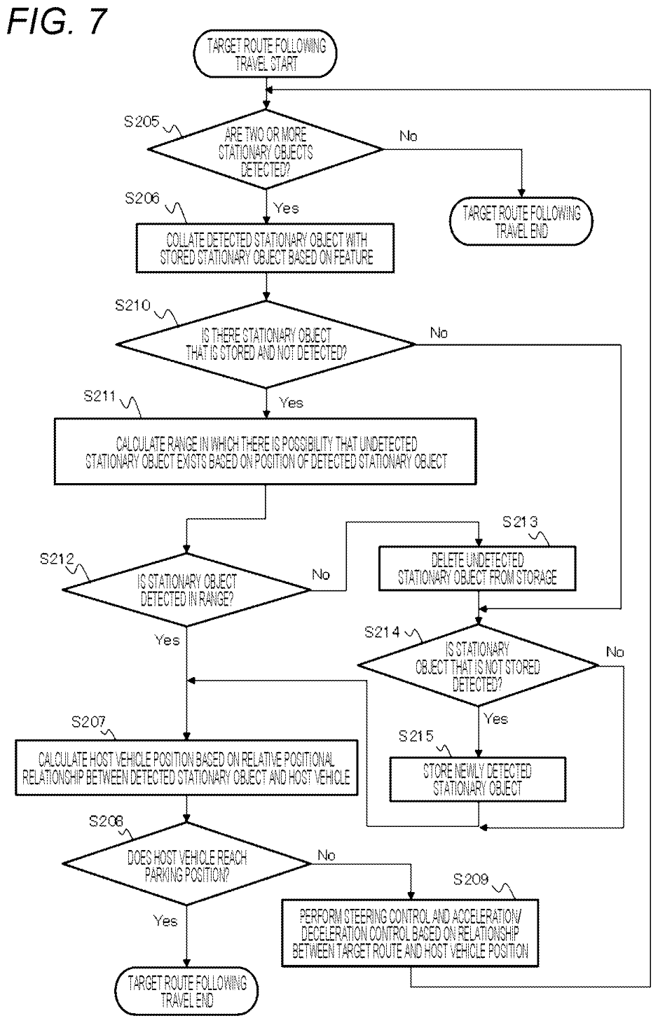

Next, the third embodiment of the present invention will be described with reference to FIG. 7.

FIG. 7 is a flowchart illustrating an example of processing executed by the vehicle control device 18 when the vehicle 1 performs following travel on the travel route 109 stored in the surrounding environment storage unit 33 as a target route in the third embodiment.

A difference from the second embodiment is addition of processing from Step S214 to Step S215, and the configuration of the vehicle 1, the configuration of the driving assistance system, and the storage processing of the travel route 109 and the route surrounding environment of the third embodiment are similar to those of the second embodiment.

The third embodiment is obtained by adding Steps S214 and S215 between Steps S213 and S207 in FIG. 6 of the second embodiment. In description below, the same steps as those in the second embodiment will not be described repeatedly.

In the third embodiment, after information on a static object for host vehicle position estimation that is not detected is deleted from the surrounding environment storage unit 33, the stored information collation unit 34 determines whether or not a static object not stored in the surrounding environment storage unit 33 is detected (Step S214).

In a case of detecting a stationary object not stored in the surrounding environment storage unit 33, the stored information collation unit 34 stores a position and a feature in the surrounding environment storage unit 33 as a new stationary object for host vehicle position estimation (Step S215).

As described above, in a case where the stationary object information for host vehicle position estimation that cannot be detected by the surrounding environment storage unit 33 is deleted, a newly detected stationary object is stored as a stationary object for host vehicle position estimation, so that robustness of the driving assistance system with respect to a change in a surrounding environment of the travel route 109 that is stored can be maintained.

### Fourth Embodiment

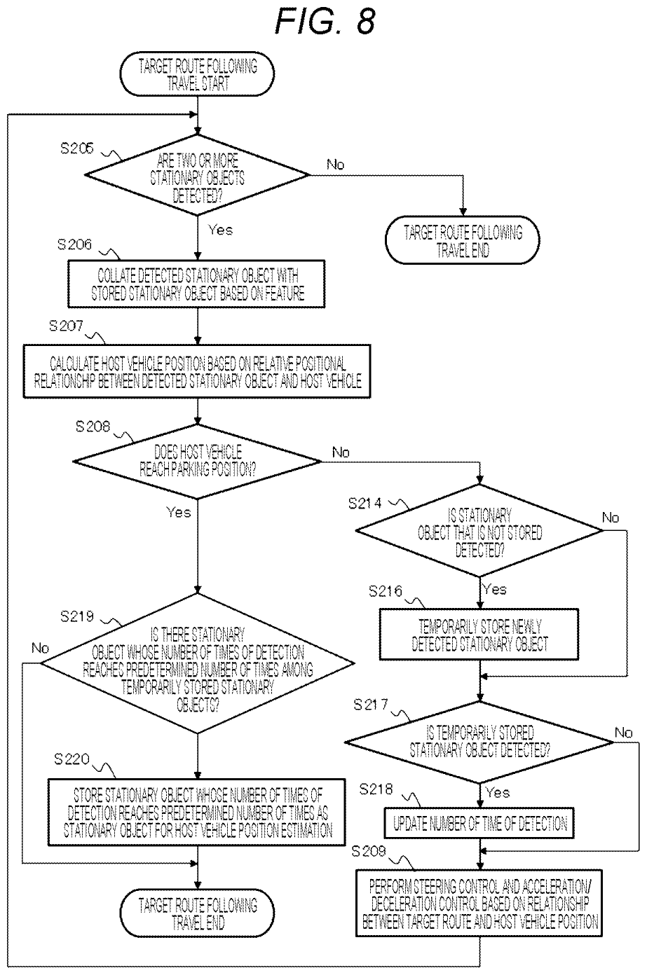

Next, the fourth embodiment of the present invention will be described with reference to FIG. 8.

FIG. 8 is a flowchart illustrating an example of processing executed by the vehicle control device 18 when the vehicle 1 performs following travel on the travel route 109 stored in the surrounding environment storage unit 33 as a target route in the fourth embodiment.

A difference between the first embodiment and the fourth embodiment is processing after Step S214 in FIG. 8, and the configuration of the vehicle 1, the configuration of the driving assistance system, and the storage processing of the travel route 109 and the route surrounding environment of the fourth embodiment are similar to those of the first embodiment.

FIG. 8 is obtained by adding processing of Steps S214 to S218 after Step S208 of FIG. 5 of the first embodiment. In description below, the same steps as those in the first embodiment will not be described repeatedly.

In the fourth embodiment, in a case where the vehicle control unit 35 determines that the vehicle 1 does not reach the parking position 101 in Step S208, the processing proceeds to Step S214 and the stored information collation unit 34 determines whether or not a new stationary object that is not stored in the surrounding environment storage unit 33 is detected by the external recognition sensor 31.

In a case where the external recognition sensor 31 detects a stationary object not stored in the surrounding environment storage unit 33, the stored information collation unit 34 temporarily stores the newly detected stationary object in the surrounding environment storage unit 33 (Step S216). Here, the stationary object that is temporarily stored is referred to as a temporarily stored stationary object. Note that the vehicle control unit 35 does not use the temporarily stored stationary object at the time of the host vehicle position estimation. Further, the stored information collation unit 34 may newly secure an area for storing the temporarily stored stationary object in the memory 3 separately from the surrounding environment storage unit 33, and store the temporarily stored stationary object in the area.

After temporarily storing the newly detected stationary object, the stored information collation unit 34 determines whether or not a stationary object stored as the temporarily stored stationary object is detected among the stationary objects detected in Step S205 (Step S217).

In a case of detecting the stationary object that is temporarily stored, the stored information collation unit updates the number of times of detection of the temporarily stored stationary object (Step S218).

The processing in Step S209 after the number of times of detection is updated is similar to that in the first embodiment. Further, in a case where the vehicle control unit 35 determines that the vehicle 1 reaches the parking position 101, the stored information collation unit 34 determines whether or not there is a stationary object whose number of times of detection reaches a predetermined number of times among the temporarily stored stationary objects (Step S219).

In a case where there is a stationary object whose number of times of detection reaches a predetermined number of times among the temporarily stored stationary objects, the stored information collation unit 34 stores the corresponding temporarily stored stationary object as a stationary object for host vehicle position estimation in the surrounding environment storage unit 33 (Step S220), and uses the temporarily stored stationary object for host vehicle position estimation at the time of the target route following travel from next time.

Further, the stored information collation unit 34 may set the predetermined number of times to be small in a case where it can be determined from a feature of the temporarily stored stationary object that the temporarily stored stationary object is highly likely to be an object that always exists in the same location, such as a traffic light or a utility pole.

Specifically, this is a case where it can be determined from an outer shape of a stationary object detected by the external recognition sensor 31 that there is a low possibility of the stationary object having a wheel. Further, in a case where a stationary object that is standardized such as a road sign and can be identified with high accuracy by pattern matching or the like is temporarily stored, the predetermined number of times may be set to be small. Note that in a case where a shape of a stationary object detected by the external recognition sensor 31 has a predetermined feature (utility pole, sign), the predetermined number of times may be set to be small.

As described above, the vehicle control device 18 of the fourth embodiment stores a stationary object newly detected during the target route following travel in the surrounding environment storage unit 33 as a stationary object for host vehicle position estimation, so that it is possible to improve the robustness of the system with respect to a change in the surrounding environment of the travel route 109 already stored.

Further, when storing a newly detected stationary object, the vehicle control device 18 can prevent the newly detected stationary object from being stored as a stationary object for host vehicle position estimation in a case where the newly detected stationary object is a movable object such as a parked vehicle by setting a limit that the number of times of detection is a predetermined number of times or more.

### Fifth Embodiment

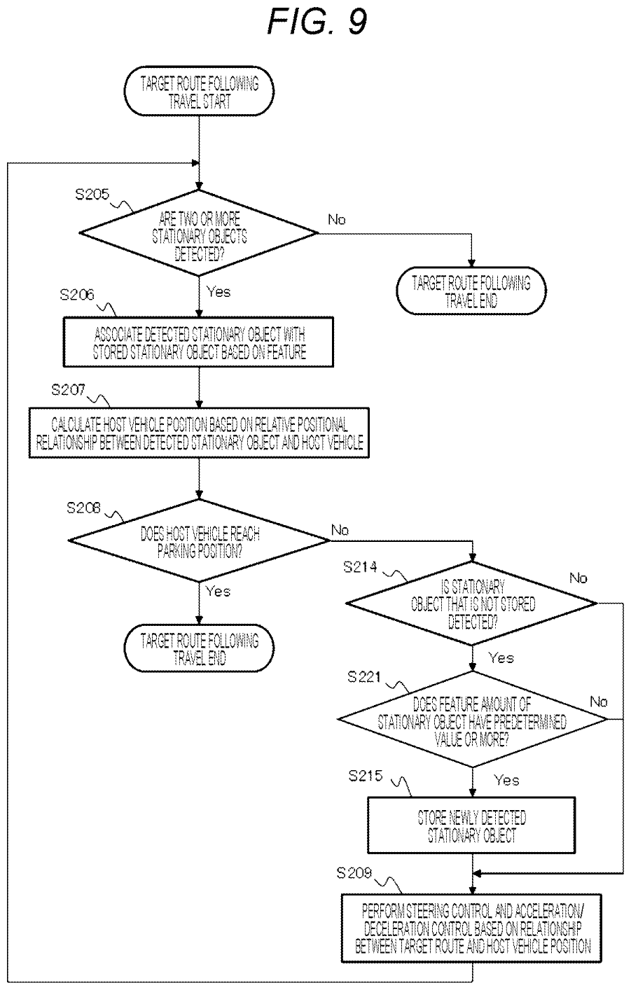

Next, the fifth embodiment of the present invention will be described with reference to FIG. 9.

FIG. 9 is a flowchart illustrating an example of processing executed by the vehicle control device 18 when the vehicle 1 performs following travel on the travel route 109 stored in the surrounding environment storage unit 33 as a target route in the fifth embodiment.

A difference between the first embodiment and the fifth embodiment is processing after Step S214 in FIG. 9, and the configuration of the vehicle 1, the configuration of the driving assistance system, and the storage processing of the travel route 109 and the route surrounding environment of the fifth embodiment are similar to those of the first embodiment.

FIG. 9 is obtained by adding processing of Steps S214 to S215 and S221 between Steps S208 and S209 of FIG. 5 of the first embodiment. In description below, the same steps as those in the first embodiment will not be described repeatedly.

In the fifth embodiment, in a case where the vehicle control unit 35 determines that the vehicle 1 does not reach the parking position 101 in Step S208, the processing proceeds to Step S214 and the stored information collation unit 34 determines whether or not a stationary object that is not stored in the surrounding environment storage unit 33 is detected by the external recognition sensor 31 (Step S214).

In a case where the external recognition sensor 31 detects a stationary object that is not stored in the surrounding environment storage unit 33, the stored information collation unit 34 calculates a feature amount of the stationary object, and determines whether or not the feature amount has a predetermined value or more (Step S221).

Specifically, for example, the stored information collation unit 34 calculates the possibility that the stationary object has a wheel from the outer shape of the stationary object detected by the external recognition sensor 31, and uses the possibility that the stationary object does not have a wheel as a feature amount. Note that the feature amount is small in a case where the possibility that the stationary object has a wheel is high, and the feature amount is large in a case where the possibility that the stationary object has a wheel is low.

In a case where a feature amount of the stationary object that is newly detected is equal to or more than a predetermined value, the stored information collation unit 34 stores the stationary object as a stationary object for host vehicle position estimation in the surrounding environment storage unit 33 (Step S215). Processing after the newly detected stationary object is stored in the surrounding environment storage unit 33 as a stationary object for host vehicle position estimation is similar to that in the first embodiment.

As described above, the vehicle control device 18 can improve the robustness of the system with respect to a change in a surrounding environment of a stored route by causing the surrounding environment storage unit 33 to store a newly detected stationary object as a stationary object for host vehicle position estimation based on a feature amount of the stationary object.

Further, when storing a newly detected stationary object, the vehicle control device 18 can prevent the newly detected stationary object from being stored as a stationary object for host vehicle position estimation in a case where the newly detected stationary object is a movable object such as a parked vehicle by setting a condition on a feature amount of a stationary object.

### Sixth Embodiment

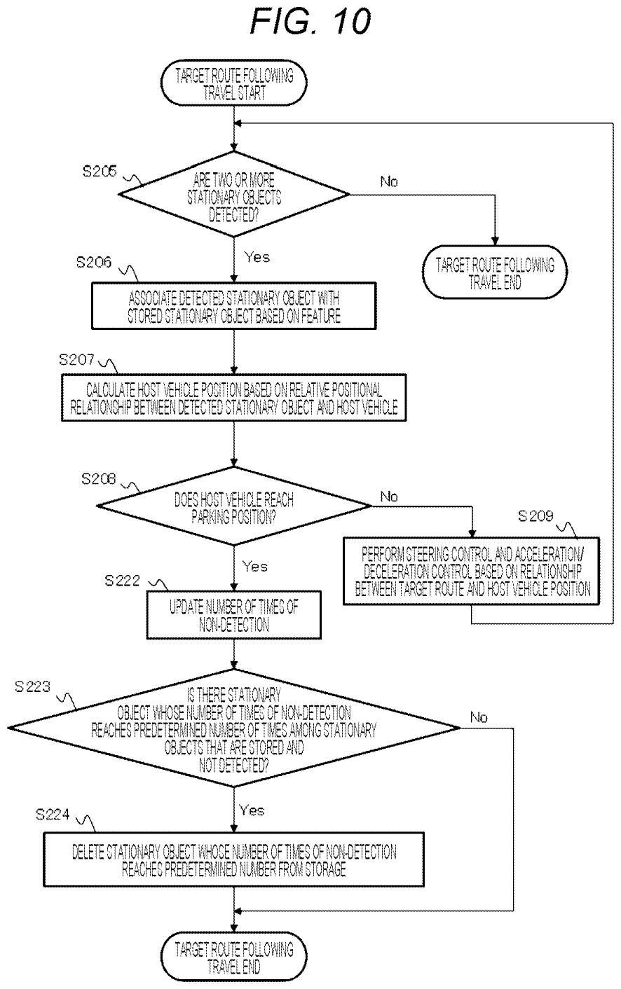

Next, the sixth embodiment of the present invention will be described with reference to FIG. 10.

FIG. 10 is a flowchart illustrating an example of processing executed by the vehicle control device 18 when the vehicle 1 performs following travel on the travel route 109 stored in the surrounding environment storage unit 33 as a target route in the sixth embodiment.

A difference between the first embodiment and the sixth embodiment is processing after Step S222 in FIG. 10, and the configuration of the vehicle 1, the configuration of the driving assistance system, and the storage processing of the travel route 109 and the route surrounding environment of the sixth embodiment are similar to those of the first embodiment.

FIG. 9 is obtained by adding processing of Steps S222 to S224 after Step S208 of FIG. 5 of the first embodiment. In description below, the same steps as those in the first embodiment will not be described repeatedly.

In the sixth embodiment, in a case where the vehicle control unit 35 determines in Step S208 that the vehicle 1 reaches the parking position 101, the processing proceeds to Step S222, and the stored information collation unit 34 updates the number of times of non-detection for a stationary object for host vehicle position estimation that is stored in the surrounding environment storage unit 33 and not detected during the target route following travel (Step S222).

The stored information collation unit 34 updates the number of times of non-detection of the stationary object for host vehicle position estimation that is detected during the target route following travel, and then determines whether or not there is a stationary object for host vehicle position estimation of which the number of times of non-detection reaches a predetermined number of times (Step S223).

The stored information collation unit 34 deletes a stationary object for host vehicle position estimation of which the number of times of non-detection reaches the predetermined number of times from the surrounding environment storage unit 33 (Step S224).

According to the above processing, it can be determined that a stationary object for host vehicle position estimation of which the number of times of non-detection reaches the predetermined number of times no longer exists, and free space of the surrounding environment storage unit 33 can be increased by deleting unnecessary information from the surrounding environment storage unit 33, and new information can be stored. Further, by setting a limit that the number of times of non-detection is equal to or more than a predetermined number of times when a stationary object that cannot be detected is deleted, it is possible to prevent deletion of a stationary object for host vehicle position estimation in a case where the stationary object cannot be detected due to performance degradation of the external recognition sensor 31 due to an influence of weather, a time zone, or the like.

### Seventh Embodiment

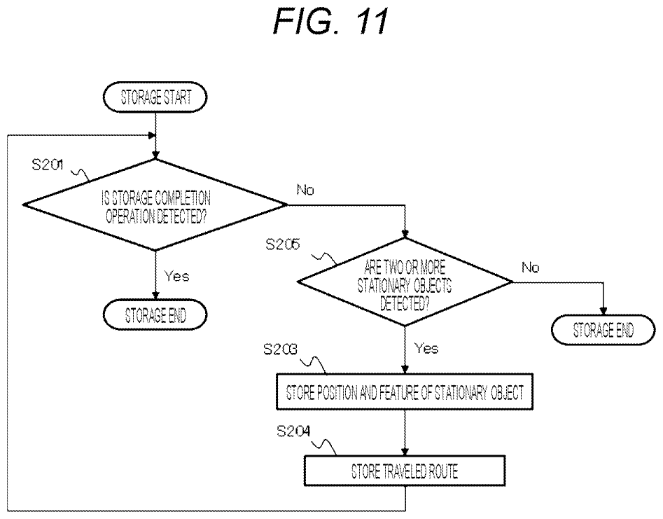

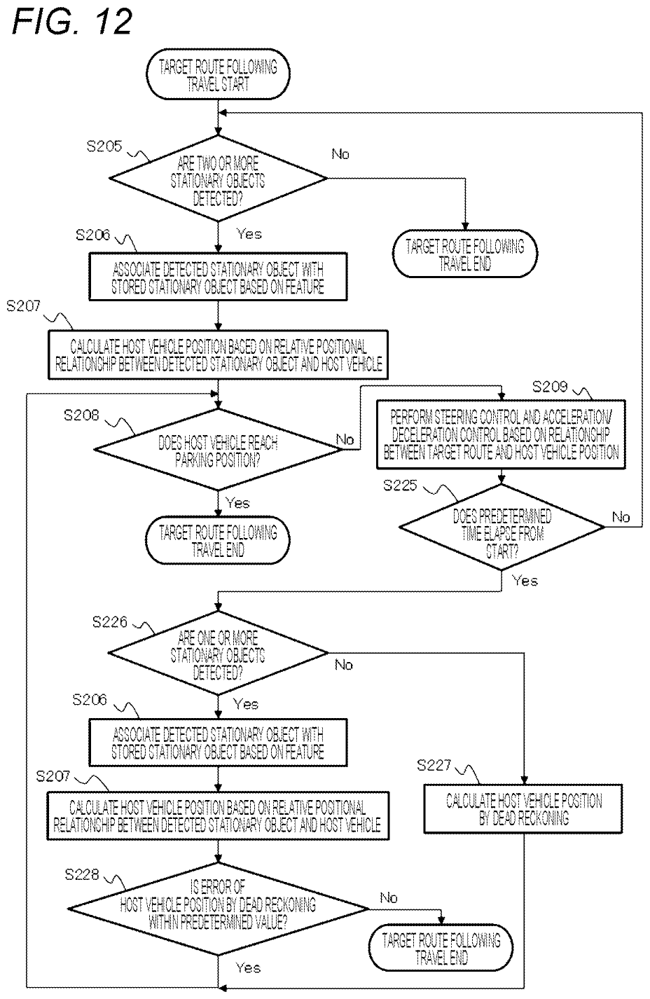

Next, the seventh embodiment of the present invention will be described with reference to FIGS. 11 and 12.

FIG. 11 is a flowchart illustrating an example of processing executed by the vehicle control device 18 when the vehicle 1 stores surrounding environment information while traveling by the user's driving in the seventh embodiment. The configuration of the vehicle 1 and the configuration of the driving assistance system of the seventh embodiment are similar to those of the first embodiment.

FIG. 11 is obtained by replacing Step S202 in FIG. 4 of the first embodiment with Step S205. In description below, the same steps as those in the first embodiment will not be described repeatedly.

In Step S205, if two or more stationary objects are detected instead of three or more as in the first embodiment, the surrounding environment storage unit 33 proceeds to Step S203 and performs similar processing as in the first embodiment.

FIG. 12 is a flowchart illustrating an example of processing executed by the vehicle control device 18 when the vehicle 1 performs following travel on the travel route 109 stored in the vehicle 1 as a target in the seventh embodiment, and a difference from the first embodiment is processing in and after Step S222. FIG. 12 is obtained by adding processing of Steps S225 to S228 after Step S209 of FIG. 5 of the first embodiment.

In the seventh embodiment, unlike the first to sixth embodiments, it is essential that the vehicle 1 include the wheel sensor 50. In addition, it is desirable that the vehicle 1 also include the steering angle sensor 28.

In the seventh embodiment, the vehicle control unit determines whether or not predetermined time elapses from the start of the target route following travel (Step S225). For example, the host vehicle position estimation unit 32 cannot estimate the host vehicle position when only one stationary object is detected immediately after the start of the target route following travel. However, the host vehicle position estimation unit 32 can estimate the host vehicle position by using the detection information and the host vehicle position immediately before even when only one stationary object is detected during the target route following travel as long as the host vehicle position can be estimated even once after the start of the target route following travel.

Specifically, for example, the host vehicle position estimation unit 32 sets, as the host vehicle position, a point that is on the circumference around a detected stationary object and with a radius between the host vehicle position and a distance from the detected stationary object and is at a shortest distance from a host vehicle position estimation value immediately before. Further, the vehicle control unit 35 may determine based on whether or not the vehicle has traveled a predetermined distance or more after starting the target route following travel instead of whether or not predetermined time has elapsed after starting the target route following travel.

Next, when predetermined time or more has elapsed since the start of the target route following travel, the stored information collation unit 34 determines whether one or more stationary objects are detected (Step S226).

In a case where no stationary object is detected, the host vehicle position estimation unit 32 estimates the host vehicle position by dead reckoning using a value of the wheel sensor 50, the steering angle sensor 28, and the like based on the host vehicle position (estimated position) immediately before (Step S227).

In contrast, in a case where one or more stationary objects are detected, the stored information collation unit 34 performs collation to determine which of the stationary objects for host vehicle position estimation stored in the surrounding environment storage unit 33 the detected stationary object corresponds to, based on a feature of the detected stationary object (Step S206).

When the collation is completed, the host vehicle position estimation unit 32 estimates the host vehicle position using a relative positional relationship with the detected stationary object (Step S207).

After calculating the host vehicle position based on a relative positional relationship with the detected stationary object, in a case where the host vehicle position is estimated by dead reckoning in Step S227 in a previous cycle, the host vehicle position estimation unit 32 determines whether a difference between the host vehicle position calculated based on a relative relationship with the detected stationary object and the host vehicle position estimated in the previous cycle is within a predetermined value (Step S228).

In a case where the difference exceeds the predetermined value, there is a high possibility of failure of the wheel sensor 50 or the steering angle sensor 28 or failure of the external recognition sensor 31, and thus the vehicle control unit 35 ends the target route following travel. When stopping the target route following travel, the vehicle control unit 35 may display a message for notifying that the target route following travel has failed on the display 37.

In a case where the difference is equal to or less than the predetermined value, the vehicle control unit 35 proceeds to Step S208 and performs processing similar to that of the first embodiment.

As described above, by using dead reckoning as the host vehicle position estimation method, the vehicle control unit 35 can estimate the host vehicle position and continue the target route following travel even when there is a moment at which no stationary object can be detected during the target route following travel.

### Eighth Embodiment

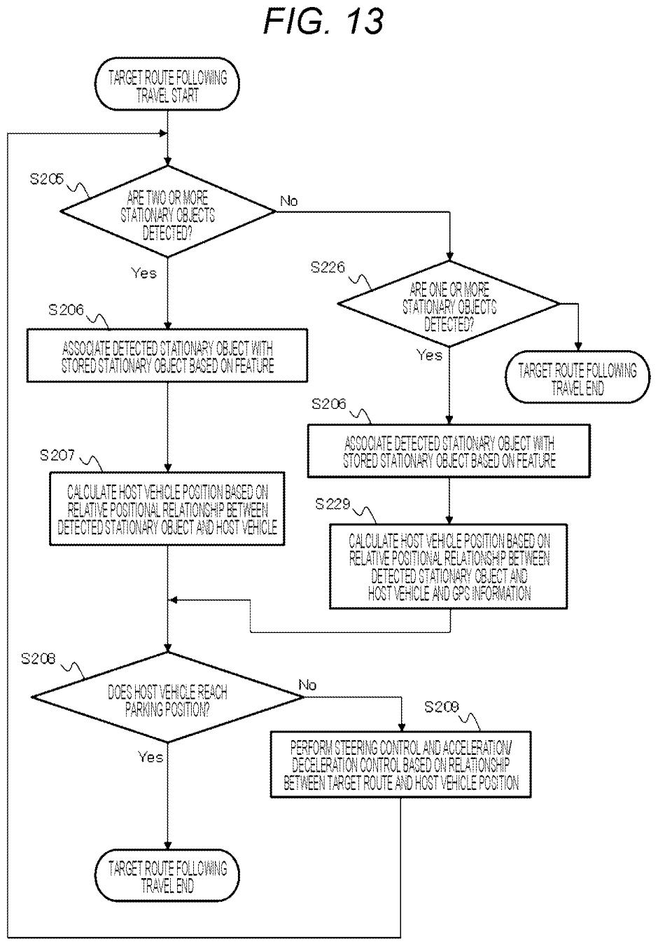

Next, the eighth embodiment of the present invention will be described with reference to FIG. 13.

In the eighth embodiment, unlike the first to seventh embodiments, it is essential that the vehicle 1 have the position detector 29.

FIG. 13 is a flowchart illustrating an example of processing executed by the vehicle control device 18 when the vehicle 1 performs following travel on the travel route 109 as a target route in the eighth embodiment.

A difference between the seventh embodiment and the eighth embodiment is that the vehicle 1 and the driving assistance system can use GPS information (position information by a positioning satellite), and processing in and after Step S205 in FIG. 13, and storage processing of a route and a route surrounding environment is the same.

In the eighth embodiment, processing in a case where two or more stationary objects are detected is similar to that in the first embodiment. FIG. 13 is obtained by adding processing of Steps S226 to S229 in a case of NO in Step S205 of FIG. 5 of the first embodiment. In description below, the same steps as those in the first embodiment will not be described repeatedly.

In a case where the number of detected stationary objects is less than 2, the stored information collation unit 34 determines whether one or more stationary objects are detected (Step S226). When the number of detected stationary objects is less than one, the stored information collation unit 34 ends the target route following travel.

When ending the target route following travel, the stored information collation unit 34 may display a predetermined message on the display 37 to notify the user that the target route following travel has failed. Further, in a case where the host vehicle position estimation unit 32 has been able to estimate the host vehicle position in the previous cycle, the host vehicle position estimation unit 32 may estimate the host vehicle position by dead reckoning using the wheel sensor 50 and the steering angle sensor 28 based on the host vehicle position calculated in the previous cycle. In a case where the host vehicle position can be estimated, the processing proceeds to Step S206.

In a case where one or more stationary objects are detected, the stored information collation unit 34 performs collation to determine which of the stationary objects for host vehicle position estimation stored in the surrounding environment storage unit 33 the detected stationary object corresponds to, based on a feature of the detected stationary object in the stored information collation unit (Step S206).

When the collation is completed, the host vehicle position estimation unit 32 estimates the host vehicle position using a relative positional relationship with the detected stationary object and GPS information (Step S229). Specifically, for example, there is a method in which the host vehicle position estimation unit 32 sets, as the host vehicle position, a point that is on the circumference around a detected stationary object and with a radius having a distance between the detected stationary object and the host vehicle and is at a shortest distance from the host vehicle position based on the GPS information. After the host vehicle position is estimated, the processing proceeds to Step S208, and processing similar to that of the first embodiment is performed.

As described above, the vehicle control device 18 according to the eighth embodiment uses GPS information in the host vehicle position estimation method, so that even when there is a moment at which two or more stationary objects cannot be detected at the same time during the target route following travel, if even one stationary object can be detected, the host vehicle position can be estimated, and the target route following travel can be continued.

Further, the processing of the first to eighth embodiments described above may be executed only at a predetermined distance with respect to a route length from a start position of a target route, or may be executed only in a location of a predetermined ratio of a rear half portion of a target route including the parking position 101. What is highly necessary to calculate the host vehicle position with high accuracy using the configurations of the first to eighth embodiments in order to accurately reach the parking position 101 is a start point of the target route following travel or a point in the vicinity of the parking position 101, and the storage capacity required in the surrounding environment storage unit 33 can be reduced by limiting a location where a plurality of stationary objects are stored for host vehicle position estimation.

Further, the surrounding environment storage unit 33 can store the surrounding environment information acquired when the vehicle travels by manual operation using the imaging sensor 17, the short-distance ranging sensor 24, the middle-distance ranging sensor 22, and the long-distance ranging sensor 25 and the travel route information. However, an amount of information to be stored may be enormous depending on the travel route 109, and thus the storage capacity may be insufficient. For the above reason, the surrounding environment information stored in the surrounding environment storage unit 33 can be accumulated in an external data center by the communication device 30 transmitting data to an external facility of the present control device capable of storing a large amount of data. At that time, a method of identifying a driver that stores the surrounding environment information is used.

Further, in a case where there is no surrounding environment information acquired when another vehicle travels by manual operation, the surrounding environment storage unit 33 can acquire, by using the communication device 30, surrounding environment information and host vehicle position information acquired when another vehicle has traveled in the past from an external data center, a road infrastructure, or the like that manages the information. By sharing the surrounding environment information in an external data center, a road infrastructure, or the like, other vehicles having different vehicle types can perform automatic travel by using the surrounding environment information in addition to the host vehicle.

### CONCLUSION

As described above, the vehicle control device of the first to eighth embodiments can have a configuration below.

(1) A vehicle control device (18) that has a processor (2) and a memory (3) and controls traveling of a vehicle (1), and includes a sensor (external recognition sensor 31) that acquires surrounding environment information of the vehicle (1), a surrounding environment storage unit (33) that acquires a stationary object from surrounding environment information acquired by the sensor (31), calculates a position of the stationary object, and stores the position of the vehicle (1) on a travel route (109) and a position of the stationary object in association with each other. The surrounding environment storage unit (33) stores three or more of the stationary objects at each position on a travel route (109) as stationary objects for host vehicle position estimation in a case of receiving a command to start storing the surrounding environment information and the travel route (109).

By the above configuration, in the vehicle control device 18, when receiving a predetermined command to start storing the surrounding environment information from the input switch unit 27, the surrounding environment storage unit 33 periodically stores the position on the travel route 109 and the stationary object for host vehicle position estimation. The surrounding environment storage unit 33 detects three or more stationary objects at each position on the travel route 109 that is periodically stored, calculates the positions and features of the stationary objects, and stores the positions and features as a stationary object for host vehicle position estimation.

(2) The vehicle control device (18) described in (1) above further including a stored information collation unit (34) that detects a stationary object in surrounding environment information acquired by the sensor (31) and identifies the stationary object for host vehicle position estimation that matches the stationary object in a case of receiving a command to follow a position on a stored travel route (109), a host vehicle position estimation unit (32) that estimates a position of the vehicle (1) from a position of an identified stationary object for host vehicle position estimation, and a vehicle control unit (35) that performs automatic driving based on the estimated position of the vehicle (1) and the stored travel route (109). The stored information collation unit (34) identifies the stationary object for host vehicle position estimation in a case where two or more of the stationary objects are detected.

By the above configuration, when the vehicle control device 18 receives, from the input switch unit 27 (input unit), a command to perform following travel on the travel route 109 as a target route, the stored information collation unit 34 detects two or more stationary objects from the surrounding environment information acquired from the external recognition sensor 31, and identifies a stationary object matching the stationary object for host vehicle position estimation stored in the surrounding environment storage unit 33. Then, the host vehicle position estimation unit 32 estimates the host vehicle position from the positions of the two or more identified stationary objects for host vehicle position estimation, and the vehicle control unit 35 performs control so that an estimated value of the host vehicle position follows the target route. In a case where the vehicle control device stores the travel route 109 and the surrounding environment information around the route, the vehicle control device 18 simultaneously stores three or more stationary objects as stationary objects for host vehicle position estimation. In this manner, even in a case where the environment around the travel route 109 changes during target route following travel and one stationary object disappears, the host vehicle position can be estimated from two or more stationary objects, and the vehicle control unit 35 can cause the vehicle 1 to travel by following the target route.

(3) The vehicle control device (18) described in (2) above, in which the stored information collation unit (34) performs detection of a stationary object again within a range in which there is a possibility that the stationary object for host vehicle position estimation exists in a case where the stationary object for host vehicle position estimation that is not included in a detected stationary object exists among the stored stationary objects for host vehicle position estimation, and, in a case where the stationary object for host vehicle position estimation is not detected as a result of the detection, deletes the stationary object for host vehicle position estimation.

By the above configuration, the vehicle control device 18 deletes information that becomes unnecessary from the surrounding environment storage unit 33, so that free space of the surrounding environment storage unit 33 can be expanded, and new information can be stored.

(4) The vehicle control device (18) described in (3) above, in which, in a case where the stationary object for host vehicle position estimation is deleted and a stationary object that is not stored as the stationary object for host vehicle position estimation is detected, the stored information collation unit (34) stores the stationary object for host vehicle position estimation as a new one of the stationary object for host vehicle position estimation.

By the above configuration, as described above, in a case where the stationary object information for host vehicle position estimation that cannot be detected by the surrounding environment storage unit 33 is deleted, a newly detected stationary object is stored as a stationary object for host vehicle position estimation, so that robustness of the driving assistance system with respect to a change in a surrounding environment of the travel route 109 that is stored can be maintained.

(5) The vehicle control device (18) described in (2) above, in which, in a case where a stationary object that does not match a stored stationary object for host vehicle position estimation is detected a predetermined number of times or more, the stored information collation unit (34) stores the stationary object as a new stationary object for host vehicle position estimation.

By the above configuration, when storing a newly detected stationary object, the newly detected stationary object can be prevented from being stored as a stationary object for host vehicle position estimation in a case where the newly detected stationary object is a movable object such as a parked vehicle by setting a limit that the number of times of detection is a predetermined number of times or more.

(6) The vehicle control device (18) described in (5) above, in which the stored information collation unit (34) calculates a feature amount of a stationary object that does not match the stored stationary object for host vehicle position estimation, and reduces the predetermined number of times when the feature amount is a predetermined value or more.

By the above configuration, when storing a newly detected stationary object, the vehicle control device 18 can prevent the newly detected stationary object from being stored as a stationary object for host vehicle position estimation in a case where the newly detected stationary object is a movable object such as a parked vehicle by setting a condition on a feature amount of a stationary object.

(7) In the vehicle control device (18) described in (5) above, in a case where a shape of a stationary object that does not match the stored stationary object for host vehicle position estimation is a predetermined shape, the stored information collation unit (34) reduces the predetermined number of times.

By the above configuration, when storing a newly detected stationary object, the vehicle control device 18 can prevent the newly detected stationary object from being stored as a stationary object for host vehicle position estimation in a case where the newly detected stationary object is a movable object such as a parked vehicle by setting a condition on a feature of a stationary object.

(8) In the vehicle control device (18) described in (2) above, in a case where a stationary object that does not match a stored stationary object for host vehicle position estimation is detected, the stored information collation unit (34) calculates a feature amount of the stationary object, and, in a case where the feature amount has a predetermined value or more, stores the stationary object as a new stationary object for host vehicle position estimation.

By the above configuration, the vehicle control device 18 can improve the robustness of the system with respect to a change in a surrounding environment of a stored route by storing a newly detected stationary object in the surrounding environment storage unit 33 as a stationary object for host vehicle position estimation based on a feature amount of the stationary object.

(9) In the vehicle control device (18) described in (2) above, the surrounding environment storage unit (33) stores a detected stationary object as a stationary object for host vehicle position estimation in a case where three of the stationary objects cannot be detected at each position on the travel route (109), and the host vehicle position estimation unit (32) estimates a position of a vehicle (1) by the stationary object for host vehicle position estimation and dead reckoning.

By the above configuration, by using dead reckoning as an estimation method for the host vehicle position, the vehicle control device 18 can estimate the host vehicle position and continue the target route following travel even when there is a moment at which no stationary object can be detected during the target route following travel.

(10) In the vehicle control device (18) described in (2) above, in a case where a stored stationary object for host vehicle position estimation is not detected a predetermined number of times, the stored information collation unit (34) deletes the stationary object for host vehicle position estimation from storage.

By the above configuration, it can be determined that a stationary object for host vehicle position estimation of which the number of times of non-detection reaches the predetermined number of times no longer exists, and free space of the surrounding environment storage unit 33 can be increased by deleting unnecessary information on the stationary object for host vehicle position estimation from the surrounding environment storage unit 33, and new information can be stored.

(11) In the vehicle control device (18) described in (2) above, in a case where number of a detected stationary object is one, the stored information collation unit (34) outputs a position of a stationary object for host vehicle position estimation that matches the stationary object, and the host vehicle position estimation unit (32) can use position information by a positioning satellite and estimates a position of a vehicle (1) from a position of the stationary object for host vehicle position estimation and position information by a positioning satellite.

By the above configuration, the vehicle control device 18 uses GPS information in the host vehicle position estimation method, so that even when there is a moment at which two or more stationary objects cannot be detected at the same time during the target route following travel, if even one stationary object can be detected, the host vehicle position can be estimated, and the target route following travel can be continued.

(12) In the vehicle control device (18) according to any one of (2) to (11) above, the surrounding environment storage unit (33) stores the stationary object as a stationary object for host vehicle position estimation in a predetermined section of a travel route (109) from the start position where a command to start storing the surrounding environment information and the travel route is received.

By the above configuration, the vehicle control device 18 can reduce the storage capacity required in the surrounding environment storage unit 33 by limiting a location where a plurality of stationary objects are stored for host vehicle position estimation.

(13) In the vehicle control device (18) according to any one of (2) to (11) above, the surrounding environment storage unit (33) stores the stationary object as a stationary object for host vehicle position estimation in a section of a predetermined ratio including an end point of the travel route (109).

By the above configuration, the vehicle control device 18 can reduce the storage capacity required in the surrounding environment storage unit 33 by limiting a location where a plurality of stationary objects are stored for host vehicle position estimation.

Note that the present invention is not limited to the above embodiment and includes a variety of variations. For example, the above embodiment is described in detail for easy understanding of the present invention, and the present invention is not necessarily limited to one that includes the entirety of the described configurations. Further, a part of a configuration of a certain embodiment can be replaced with a configuration of another embodiment, and a configuration of a certain embodiment can also be added to a configuration of another embodiment. Further, for a part of the configuration of each embodiment, any addition, deletion, or replacement of other configurations can be applied alone or in combination.

Further, a part or the whole of the above configurations, functions, processing units, processing means, and the like may be obtained as hardware by way of, for example, designing them as an integrated circuit. The above configurations, functions, and the like may be obtained by software by which a processor interprets and executes programs that perform functions of them. Information, such as a program that performs each function, a table, and a file, can be placed in recording devices, such as a memory, a hard disk, and a solid state drive (SSD), or recording media, such as an IC card, an SD card, and a DVD.

Further, a control line and an information line that are considered necessary for explanation are shown, and not all control lines or information lines on a product are necessarily shown. In practice, almost all configurations may be considered to be connected mutually.

### REFERENCE SIGNS LIST

1 vehicle
11 engine
12 automatic transmission
13 propeller shaft
14 differential gear
15 drive shaft
16 wheel
17 imaging sensor
18 vehicle control device
19 various sensors
20 brake device
21 electric power steering
24 short-distance ranging sensor
22 middle-distance ranging sensor
25 long-distance ranging sensor
27 input switch unit
29 position detector
30 communication device
31 external recognition sensor
32 host vehicle position estimation unit
33 surrounding environment storage unit
34 stored information collation unit
35 vehicle control unit
36 various sensor/actuator ECU
37 display
38 sound output unit
39 steering control unit
40 acceleration/deceleration control unit
41 shift control unit
50 wheel sensor

1. A vehicle control device that has a processor and a memory and controls traveling of a vehicle, the vehicle control device comprising:
a sensor that acquires surrounding environment information of the vehicle; and
a surrounding environment storage unit that acquires a stationary object from surrounding environment information acquired by the sensor, calculates a position of the stationary object, and stores the position of the vehicle on a travel route and a position of the stationary object in association with each other, wherein
the surrounding environment storage unit stores three or more of the stationary objects at each position on a travel route as stationary objects for host vehicle position estimation in a case of receiving a command to start storing the surrounding environment information and the travel route.

2. The vehicle control device according to claim 1, further comprising:
a stored information collation unit that detects a stationary object in surrounding environment information acquired by the sensor and identifies the stationary object for host vehicle position estimation that matches the stationary object in a case of receiving a command to follow a position on a stored travel route;
a host vehicle position estimation unit that estimates a position of the vehicle from a position of an identified stationary object for host vehicle position estimation; and
a vehicle control unit that performs automatic driving based on an estimated position of the vehicle and the stored travel route, wherein
the stored information collation unit identifies the stationary object for host vehicle position estimation in a case where two or more of the stationary objects are detected.

3. The vehicle control device according to claim 2, wherein
the stored information collation unit performs detection of a stationary object again within a range in which there is a possibility that the stationary object for host vehicle position estimation exists in a case where the stationary object for host vehicle position estimation that is not included in a detected stationary object exists among the stored stationary objects for host vehicle position estimation, and, in a case where the stationary object for host vehicle position estimation is not detected as a result of the detection, deletes the stationary object for host vehicle position estimation.

4. The vehicle control device according to claim 3, wherein
in a case where the stationary object for host vehicle position estimation is deleted and a stationary object that is not stored as the stationary object for host vehicle position estimation is detected, the stored information collation unit stores the stationary object for host vehicle position estimation as a new one of the stationary object for host vehicle position estimation.

5. The vehicle control device according to claim 2, wherein
in a case where a stationary object that does not match a stored stationary object for host vehicle position estimation is detected a predetermined number of times or more, the stored information collation unit stores the stationary object as a new stationary object for host vehicle position estimation.

6. The vehicle control device according to claim 5, wherein
the stored information collation unit calculates a feature amount of a stationary object that does not match the stored stationary object for host vehicle position estimation, and reduces the predetermined number of times in a case where the feature amount is a predetermined value or more.

7. The vehicle control device according to claim 5, wherein
in a case where a shape of a stationary object that does not match the stored stationary object for host vehicle position estimation is a predetermined shape, the stored information collation unit reduces the predetermined number of times.

8. The vehicle control device according to claim 2, wherein
in a case where a stationary object that does not match a stored stationary object for host vehicle position estimation is detected, the stored information collation unit calculates a feature amount of the stationary object, and, in a case where the feature amount has a predetermined value or more, stores the stationary object as a new stationary object for host vehicle position estimation.

9. The vehicle control device according to claim 2, wherein
the surrounding environment storage unit stores a detected stationary object as a stationary object for host vehicle position estimation in a case where three of the stationary objects cannot be detected at each position on the travel route, and
the host vehicle position estimation unit estimates a position of a vehicle by the stationary object for host vehicle position estimation and dead reckoning.

10. The vehicle control device according to claim 2, wherein
in a case where a stored stationary object for host vehicle position estimation is not detected a predetermined number of times, the stored information collation unit deletes the stationary object for host vehicle position estimation from storage.

11. The vehicle control device according to claim 2, wherein
in a case where number of a detected stationary object is one, the stored information collation unit outputs a position of a stationary object for host vehicle position estimation that matches the stationary object, and
the host vehicle position estimation unit can use position information by a positioning satellite and estimates a position of a vehicle from a position of the stationary object for host vehicle position estimation and position information by a positioning satellite.

12. The vehicle control device according to claim 2, wherein
the surrounding environment storage unit stores the stationary object as a stationary object for host vehicle position estimation in a predetermined section of a travel route from a start position where a command to start storing the surrounding environment information and the travel route is received.

13. The vehicle control device according to claim 2, wherein
the surrounding environment storage unit stores the stationary object as a stationary object for host vehicle position estimation in a section of a predetermined ratio including an end point of the travel route.
